(19) United States
(12) Patent Application Publication
(10) Pub. No.: US 2018/0199731 A1
(43) Pub. Date: Jul. 19, 2018

(54) MATTRESS WITH EMBEDDED HEAD SUPPORT FOR INFANTS

(71) Applicant: General Electric Company, Schenectady, NY (US)

(72) Inventors: Karen P. Starr, Laurel, MD (US); Steven M. Falk, Laurel, MD (US); Christen Pechman Bartley, Laurel, MD (US)

(73) Assignee: General Electric Company, Schenectady, NY (US)

(21) Appl. No.: 15/405,479

(22) Filed: Jan. 13, 2017

(51) Int. Cl. A47D 15/00; A47D 9/00; A61G 7/07

(52) U.S. Cl. CPC A47D 15/008; A61G 7/072; A47D 9/00; A47D 15/001

(57) ABSTRACT

A mattress for supporting a head and body of a patient is disclosed. The mattress includes an integrated deformable head support that can be molded into a desired shape to support the head of the infant. The deformable head support retains the desired shape after molding. The head support is received upon and extends above a top surface of a base layer of the mattress. The base layer and head support are formed from different materials where the material used to form the head support can be deformed and retains the desired shape. The head support has a U-shape or semi-ring shape to surround the top and sides of the head of an infant patient when the infant patient is positioned on the mattress. A cover layer is positioned over both the base layer and the head support.

### BACKGROUND

The present disclosure generally relates to a mattress for use in supporting the head of an infant while the infant is on the mattress. More specifically, the present disclosure relates to a mattress that includes a deformable head support to aid in maintaining the position of an infant's head while the infant is within the infant is cared for on a radiant warmer, incubator or bassinet.

Prematurely born and sick newborn infants require specialized treatment and care due to their small size and still-developing organs and physiological systems. After being born, premature infants are typically placed in devices that create a carefully controlled micro-environment around the patient. The infant care devices operate to control environmental conditions of the micro-environment, such as oxygen concentration, temperature, humidity and light in such a manner as to promote the health and well-being of the infant patient. Radiant warmers also serve as an infant care device by providing controlled thermoregulation through operation of a heating element.

One type of infant care device that creates the microenvironment is generally referred to as an incubator in which the patient is placed within a physical enclosure and the temperature within the enclosure is carefully controlled with convective heating provided by a forced flow of heated air into the enclosure. Within the micro-environment, the oxygen concentration and humidity can also be accurately controlled.

Another type of infant care device that aides to support thermoregulation is referred to as a radiant warmer. The radiant warmer has an overhead heating elements that produce radiant heat directed downward onto the infant patient to maintain the infant temperature.

Hybrid systems are another type of infant care device that incorporates both convective heating systems and radiant heating systems.

When sick newborns or prematurely born infants are placed in an infant care device, it is often desirable to maintain the position of the infant's head in a midline position. Maintaining the midline position of the head has been shown to reduce intraventricular hemorrhages. Presently, clinicians utilize various different makeshift supports to aid in maintaining the midline position of the infant's head. These makeshift supports include rolling towels to create a semi-ring shaped roll that is located around the top and sides of the infant head. These types of makeshift supports require additional action by the clinician and can be displaced or moved inadvertently when treating the infant patient.

### SUMMARY

The present disclosure relates to a mattress that includes a deformable head support to aid in maintaining the position of an infant's head, such as while the infant is located within an infant care device. The mattress is particularly useful in maintaining the position of an infant head in a midline position.

The mattress includes a base layer that is formed from a first material and is sized to support the body of an infant patient when the infant patient is positioned on the mattress. In one embodiment, the base layer is formed from a foam material. In one embodiment, the base layer includes a cavity that is recessed from a top surface of the base layer at a location that corresponds to the preferred position of the head of an infant patient when the infant patient is positioned on the mattress.

The mattress further includes a deformable head support that extends above the top surface of the base layer. In one embodiment, the head support is received within the cavity of the base layer. The head support is formed from a second material that is deformable and can be molded into a desired shape and subsequently retains the desired shape. During use, the head support can be deformed by a clinician into the desired shape sized to receive the head of an infant patient. The head support extends above the top surface of the base layer and can be molded by a clinician to surround the top and sides of the infant head.

The deformable head support includes an enclosed outer casing that surrounds the second material. In one embodiment of the disclosure, the second material is a gel that is moldable into the desired shape and, after molding, retains the desired shape. Other similar materials are contemplated as long as the material is able to be molded into the desired shape and subsequently retains the desired shape. The head support has a generally U-shape or a semi-ring shape such that the head support can surround the sides and top of the infant's head.

In one embodiment of the disclosure, a cover layer is attached to the top surface of the base layer and covers both the head support and the base layer. The cover layer can be formed form various materials that are durable, comfortable and can be easily cleaned.

The mattress of the present disclosure can be removed from within the infant care device, such as a warmer, incubator or bassinet, as desired. The mattress is sized similar to a conventional mattress such that the mattress of the present disclosure can replace a standard mattress.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is an environmental view that depicts an exemplary embodiment of an infant care device;

FIG. 2 exhibits an exemplary embodiment of an infant care device;

FIG. 3 is a top view of an infant patient supported on the mattress of the present disclosure;

FIG. 4 is a section view taken along line 4-4 of FIG. 3;

FIG. 5 is a top plan view of the base layer of the mattress;

FIG. 6 is a top view of the deformable head support of the present disclosure;

FIG. 7 is a section view taken along line 7-7 of FIG. 6; and

FIG. 8 is a partial section view showing the deformation of the head support by a clinician.

### DETAILED DESCRIPTION

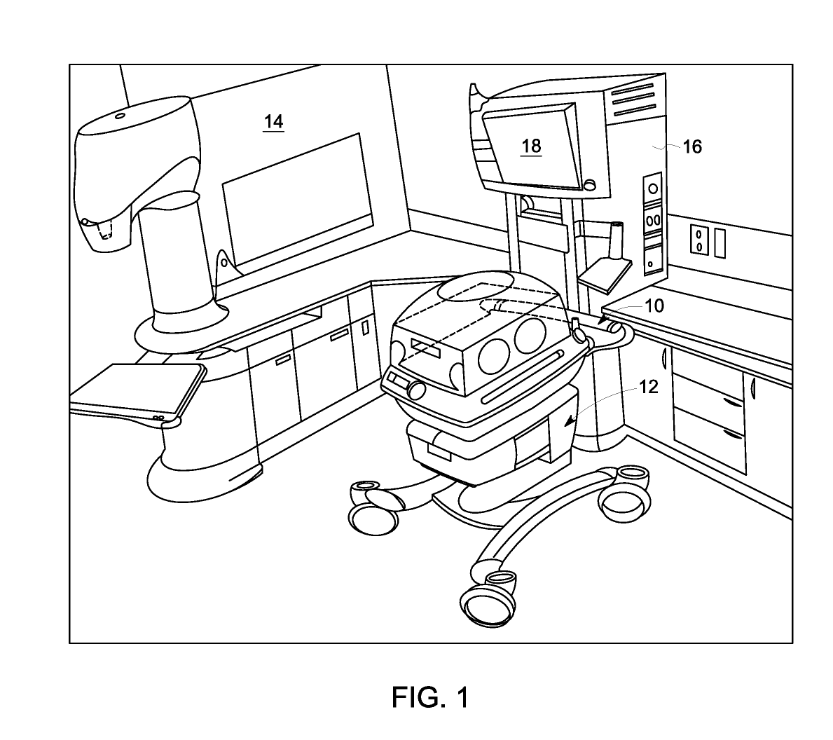

FIG. 1 depicts an environmental view of an infant care device 10. The infant care device 10 is depicted in this embodiment as an incubator; however, it will be recognized and understood from the disclosure and examples given herein that alternative embodiments of the infant care device 10 may include, but are not limited to, an incubator, a warmer, a hybrid warmer/incubator or a bassinet.

The infant care device 10 includes a mobile base 12 such that the infant care device 10 can be moved about a medical care facility, such as into a neonatal intensive care unit (NICU) 14. In the embodiment depicted in FIG. 1, the infant care device 10 is communicatively connected to a NICU workstation 16 that in embodiments provide additional functionality and data connections to the infant care station 10. The NICU workstation 16 can include a graphical display 18 that presents patient information to a clinician. As detailed herein, the graphical display 18 may be a touch-sensitive graphical display. In other embodiments, the graphical display 18 could be mounted to the infant care device 10.

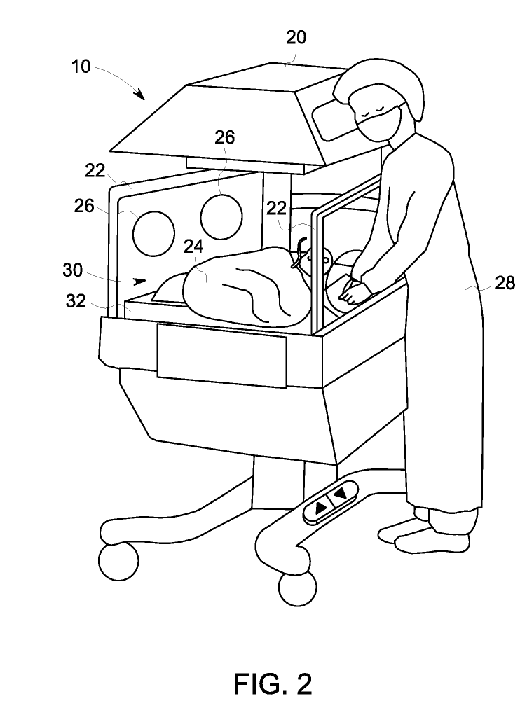

FIG. 2 depicts an exemplary embodiment of an infant care device in which the infant care device is a hybrid infant care station that can functionally operate as either a warmer or an incubator. The hybrid infant care station includes an overhead canopy 20 that is separate from the walls 22 that create a microenvironment 30 for the infant patient 24. The walls 22 include one or more arm ports 26 through which the clinician 28 can access the infant patient 24 located within microenvironment 30. The patient 24 is supported on a mattress 32 constructed in accordance with the present disclosure and as will be described in much greater detail below. When the infant patient 24 is located within the infant care device 10, the infant patient can be monitored using a wide variety of patient monitoring sensors and devices. When the infant care device 10 is used with a pre-term infant, it is proven desirable to maintain the proper midline positioning of the head to help reduce intraventricular hemorrhages. The mattress 32 of the present disclosure has been designed to aid in maintaining midline positioning of the head.

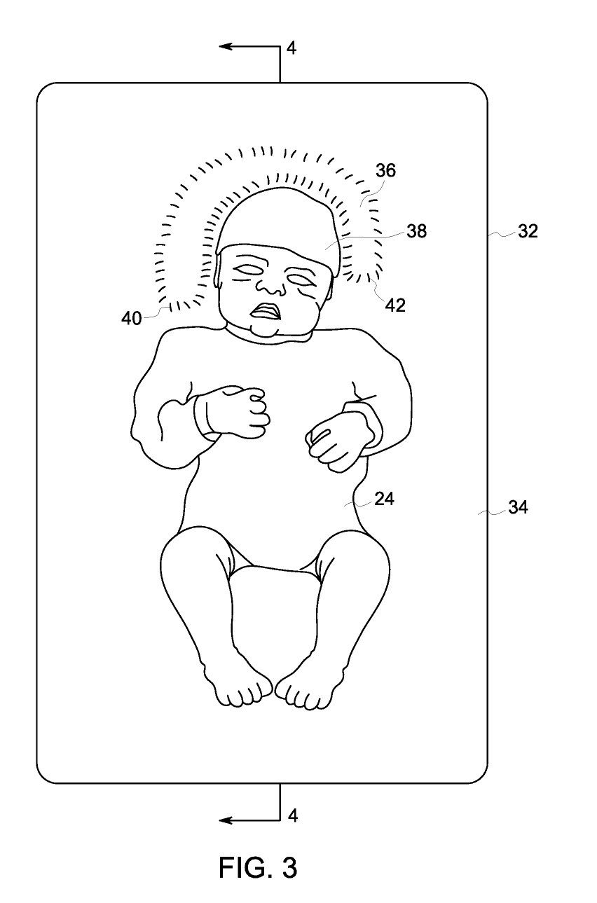

Referring now to FIG. 3, the mattress 32 of the present disclosure is shown supporting the infant patient 24. The infant patient 24 is positioned on the generally planar support surface 34 created by the mattress 32. The mattress 32 includes a head support 36 positioned to support the head 38 of the infant patient 24 when the infant patient 24 is positioned on the mattress 32. In the embodiment shown in FIG. 3, the head support 36 protrudes above the support surface 34 and has a generally U-shaped configuration. The head support 36 surrounds the top and sides of the head 38 and terminates at first and second ends 40, 42 that are located on opposite sides of the infant head 38. The distance between the first and second ends 40, 42 is selected to allow the infant head 38 to be securely positioned between the first and second ends 40, 42. The head support 36 could have shorter sides to have a semi-ring shape or the sides could be extended to form the generally U-shape shown in FIG. 3.

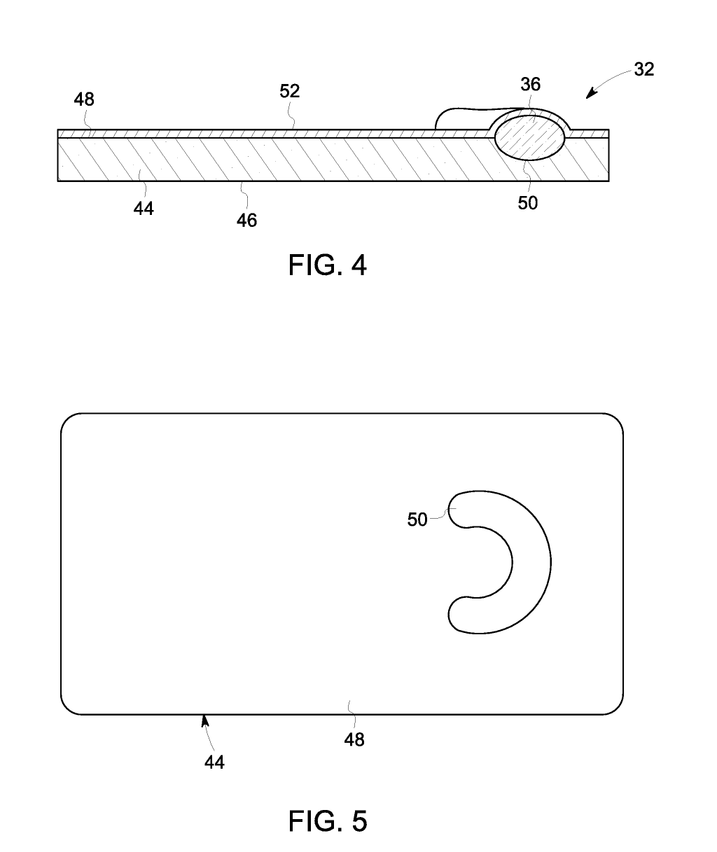

As illustrated in the section view of FIG. 4, the mattress 32 includes a base layer 44 that is formed from foam or other type material typically used in an infant mattress. The base layer 44 includes a bottom surface 46 and a top surface 48 that combine to define the thickness of the base layer 44. In the embodiment shown, a cavity 50 is formed in the base layer 44 and is open to the top surface 48. FIG. 5 is a top view of only the base layer 44 and illustrates the position of the cavity 50 relative to the ends and sides of the base layer 44. The cavity 50 is recessed from the top surface 48. The cavity 50 has a U-shape or semi-ring shape and is located in a desired position to support the head of an infant, as was shown and described in FIG. 3.

Referring back to FIG. 4, the head support 36 is shown positioned within the cavity 50. The head support 36 is formed from a deformable material that is different from the material used to form the base layer 44. FIG. 4 illustrates the head support 36 without an infant patient on the mattress 32. Although the embodiment shown in FIG. 4 includes the cavity 50 formed in the base layer 44, it is contemplated that the cavity 50 could be eliminated. In such an embodiment, the head support 36 would rest on the top surface 48 and would compress the foam material of the base layer 44 to hold the base layer 44 in place.

The mattress 32 further includes a cover layer 52 that is positioned over both the base layer 44 and the head support 36 to provide a uniform and comfortable support surface for the infant patient. The cover layer 52 can be formed from a wide variety of material, such as a woven microfiber that is both comfortable and can be easily cleaned. The cover layer 52 is preferably somewhat elastic to move with the deformable head support 36 as will be described in detail below. Although the cover layer 52 is shown in the embodiment of FIG. 4, it should be understood that the cover layer 52 could be removed while operating within a contemplated embodiment of the present disclosure.

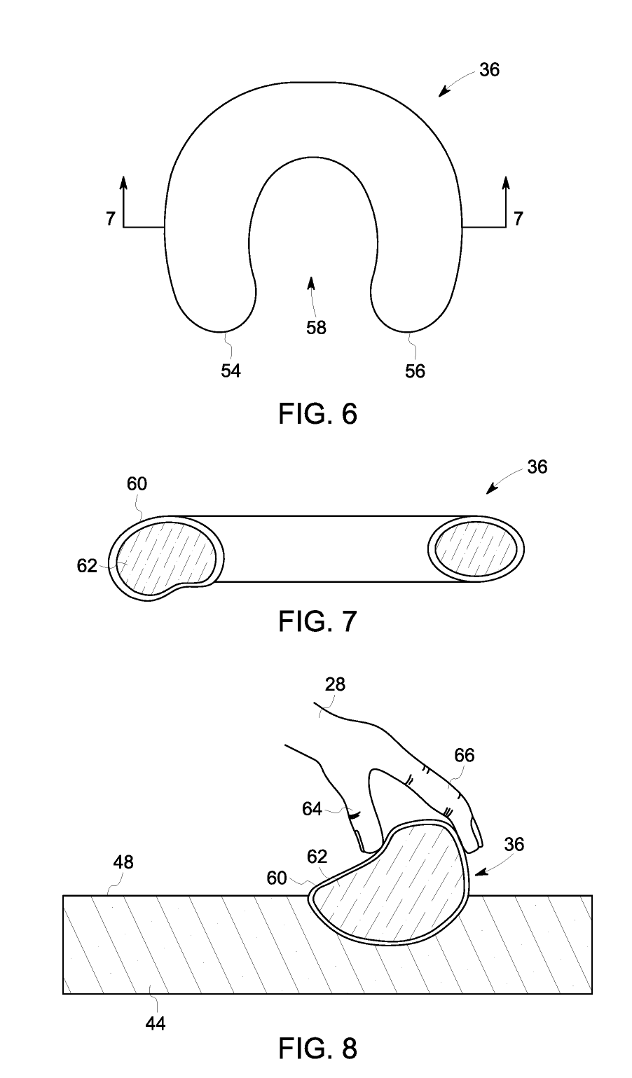

FIGS. 6 and 7 illustrate the head support 36 removed from the mattress. The head support 36 is a generally U-shaped or semi-ring shaped member and extends between a first end 54 and a second end 56. The first and second ends 54, 56 are spaced from each other to define an open space 58 that can receive the neck of the infant patient.

As illustrated in FIG. 7, the head support 36 includes an outer casing 60 that surrounds a deformable material 62. The outer casing 60 can be formed from multiple materials, such as silicon, thermoplastic, neoprene or similar type material that is both flexible and durable enough to entrap the deformable material 62. In the embodiment shown in FIG. 7, the deformable material 62 is a gel having the required thickness such that the shape of the head support 36 can be molded into a desired shape and the deformable material will retain the desired shape. Although various different types of gels are contemplated as being used for the deformable material 62, it should be understood that other types of materials that can be deformed and retain a desired shape could be utilized while operating within the scope of the present disclosure. These materials could include beads formed from various materials or a highly viscous liquid.

As shown in FIG. 8, the clinician 28 can manipulate the head support 36 into a desired shape by using a thumb 64 and one or more fingers 68 to squeeze the head support 36 into a desired shape or configuration. When squeezed, the deformable material 62 moves within the flexible outer casing 60 and retains the shape created by the clinician 28. In the embodiment shown in FIG. 8, a larger portion of the deformable material 62 is pushed away from the center of the mattress to generally increase the area for the infant's head. If the infant's head was smaller, the clinician 28 would move the deformable material 62 in the opposite direction. Once the clinician 28 has molded the head support in the desired shape and configuration, the clinician 28 can remove his or her hand and the deformable material 62 will retain the desired shape. As can be understood, once the infant patient is removed from the mattress and the mattress is used with another infant patient, the clinician 28 can reconfigure the shape of the head support 36 based upon the individual infant patient.

In the embodiment shown in FIG. 8, the cover layer 52 shown in FIG. 4 has been removed for the ease of understanding. It should be understood that the cover layer 52 would extend over the entire base layer 44 and be attached to the top surface 48. The cover layer would also extend over the head support 36 as previously described.

The mattress 32 shown in FIG. 3 can be removed and replaced from the infant care device when the infant care device is used with a patient that needs additional support and positioning of the head to reduce intraventricular hemorrhages. When an infant patient does not need such support, a typical mattress would then be utilized within the infant care device.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A mattress for supporting a head and a body of a patient, comprising:
a base layer formed from a first material and configured to support the body of the patient, the base layer including a top surface; and
a deformable head support including a deformable second material and received on and extending above the top surface, the head support being configured to support the head of the patient.

2. The mattress of claim 1 wherein the deformable head support includes an enclosed outer casing surrounding the second material.

3. The mattress of claim 2 wherein the second material is a deformable gel that is moldable into and retains a desired shape.

4. The mattress of claim 1 further comprising a cover layer attached to the top surface of the base layer and covering the head support.

5. The mattress of claim 1 wherein the head support is generally U-shaped.

6. The mattress of claim 1 wherein the head support is semi-ring shaped.

7. The mattress of claim 1 wherein the first material is foam and the second material is a deformable gel.

8. A mattress for supporting a head and a body of an infant, comprising:
a base layer formed from a first material and configured to support the body of the infant, the base layer including a cavity recessed from a top surface of the base layer; and
a deformable head support including a second material that is moldable into and retains a desired shape, the head support being received within the cavity of the base layer and extending above the top surface, the head support being moldable into the desired shape to support the head of the infant.

9. The mattress of claim 8 wherein the deformable head support includes an enclosed outer casing surrounding the second material.

10. The mattress of claim 8 further comprising a cover layer attached to the top surface of the base layer and covering the head support.

11. The mattress of claim 8 wherein the cavity is generally U-shaped.

12. The mattress of claim 8 wherein the cavity and the head support are both semi-ring shaped.

13. The mattress of claim 8 wherein the first material is foam and the second material is a deformable gel.

14. A mattress for use in infant care station for supporting a head and a body of an infant, comprising:
a base layer formed from a first material and configured to support the body of the infant, the base layer including a top surface;
a deformable head support including a second material that is moldable into and retains a desired shape, the head support being received on the top surface of the base layer and extending above the top surface, the head support being moldable into the desired shape to support the head of the infant; and
a cover layer attached to the top surface of the base layer and covering the head support.

15. The mattress of claim 14 wherein the deformable head support includes an enclosed outer casing surrounding the second material.

16. The mattress of claim 14 wherein the head support is generally U-shaped.

17. The mattress of claim 14 wherein the head support is semi-ring shaped.

18. The mattress of claim 14 wherein the first material is foam and the second material is a deformable gel.

19. The mattress of claim 14 wherein the base layer includes a cavity recessed from a top surface of the base layer.

20. The mattress of claim 19 wherein the head support and the cavity are both generally U-shaped.
